(19) United States
(12) Patent Application Publication
(10) Pub. No.: US 2009/0206014 A1
(43) Pub. Date: Aug. 20, 2009

(54) Memory Module for Flat Objects

(75) Inventor: Peter Enenkel, Konstanz (DE)

Correspondence Address: LERNER GREENBERG STEMER LLP, P O BOX 2480, HOLLYWOOD, FL, 33022-2480, US

(73) Assignee: SIEMENS AKTIEGESELLSCHAFT, Munchen (DE)

(21) Appl. No.: 12/389,092

(22) Filed: Feb. 19, 2009

(30) Foreign Application Priority Data
Feb. 20, 2008 (DE) 10 2008 009 971.6

(51) Int. Cl. B07C 7/02

(52) U.S. Cl. 209/630

(57) ABSTRACT

A storage module for flat articles, has a storage region for a stack of articles, an introduction unit for the introduction of articles from an article stream into the storage region, and a draw-off unit arranged at the same end of the stack as the introduction unit, for drawing off articles from the storage region. The storage module has a movement device for moving the stack away from the introduction unit toward the draw-off unit. The storage module thus provides for an intermediate storage of the articles, which is protective of the mail items.

The invention relates to a storage module for flat articles, with a storage region for a stack of articles, with an introduction means for the introduction of articles from an article stream into the storage region, and with a draw-off means, arranged at the same end of the stack as the introduction means, for drawing off articles from the storage region.

Flat articles, such as letters, large letters, postcards, sealed-up periodicals and the like, are sorted in very large numbers according to their address in postal centers or large post offices and, if appropriate after being presorted, are filed in a multiplicity of stacking compartments. To sort the articles according to their address, it is indispensable to detect the address of as far as possible each article mechanically at least at the start of the sorting process.

Depending on how the address is applied to the article, the address can be detected mechanically more or less easily, although the address of some of the articles to be sorted usually cannot be detected mechanically. It has to be fed into the system by means of a manual input. For this purpose, an image of the article having the undetected address is brought up on a video display unit, the address is read by an operator and input via the keyboard. Such an operation takes up some time. This situation makes it necessary for the further processing of the articles having the mechanically unreadable addresses to be delayed until their address is known to the system.

For this purpose, storage zones are known, in which, for example, all the articles are transported to and fro as long as there is sufficient time available for the manual identification of the non-read addresses. Another solution to this problem provides for the mechanically unreadable mail items to be transferred out of the sorting process and intermediately stored in a storage module. After the manual assignment of the address, the articles are drawn off from the storage module again and introduced into the sorting process.

A storage module for the reception of articles which are to be intermediately stored is known, for example, from EP 1 872 865 A2. The storage module operates in the last-in/first-out mode in which the article stored last is drawn off first and separated. It comprises an introduction means in the form of two endless belts which lie opposite one another and between which the articles are delivered to a storage region for the reception of stacked articles. For stacking the articles into the storage region, moreover, the introduction means comprises a roller conveyor unit which draws in a transported article, rotates it a little and places it on the stack. To draw off the stacked articles, these are pressed onto the roller conveyor unit, a feed stop is opened, and the articles are drawn off successively by the roller conveyor unit and separated.

An object of the present invention is to specify a storage module for flat articles, by means of which an introduction and draw-off of the articles can be carried out particularly carefully with regard to the consignments involved.

This object is achieved by means of a storage module of the type initially mentioned which, according to the invention, has a movement means for moving at least such a part of the stack which comprises an article last deposited in the storage region away from the introduction means and toward the draw-off means. The introduction means and the draw-off means may operate as separate units, for example without a roller conveyor unit being used either for stacking or for drawing off. As a result, introduction which is careful with regard to the consignments involved and which has low static friction can be carried out, and draw-off can take place with high static friction for the rapid and reliable acceleration of the articles.

The invention is in this case based on the consideration that articles to be stacked are shot in onto the end of the stack and butt against a stop for stopping an introduction movement, with the result that a uniform stack formation can be achieved. The movement of the articles is in this case pursued as far as the stop at the introduction means, so that the latter also comes into contact with the article when the articles are stopped at the stop. Since a relative speed between the supported articles and the supporting element cannot be avoided, support should take place with a very low coefficient of friction, in order to avoid a creasing of the articles.

When the articles are being drawn off from the stack, they are accelerated sharply. To achieve the high acceleration, the draw-off means must engage with high friction on the article to be drawn off in each case. The draw-off means therefore expediently has high static friction with respect to the articles. Since the introduction means is intended for introducing the articles independently into the storage region and the draw-off means is present as an additional component to the introduction means, that is to say due to the separation of the introduction means and draw-off means, the articles, when being stored and when drawn off, are treated with means completely separate from one another, so that the friction occurring between the means and the articles can be optimized in terms of the process to be carried out in each case.

The storage module is expediently a last-in/first-out module in which the article stored last is drawn off first. The flat articles may be mail items of any type, in particular postal consignments, the thickness of which preferably does not overshoot 20% of their height. The height relates to an article which is standing on a longitudinal edge. The draw-off means expediently has a draw-off element for drawing on an article to be drawn off, said element applying a force in the draw-off direction to the articles, that is to say drawing these off. The introduction means serves for the introduction of articles from an article stream into the storage region.

An article stream comprises a plurality of articles transported one behind the other and in each case standing on their longitudinal edge. It may comprise an introduction element for pushing an article into the storage region, the draw-off element having a higher coefficient of friction than the introduction element. The coefficient of friction may be seen in relation to paper. The introduction element may be a revolving endless belt, and the draw-off element likewise, or the latter may be formed by one or more rollers. The movement of the stack or a part of the stack away from the introduction means and toward the draw-off means may be designated as a changeover movement for changing over the storage module from an introduction operating mode to a draw-off operating mode, even though it is generally designated below merely as the movement.

In an advantageous refinement of the invention, the storage module comprises a drive for moving a stack carrier for holding the stack of articles from the introduction means to the draw-off means. The movement of the stack in relation to the introduction means and to the draw-off means can thereby take place in a mechanically driven manner, with high power, swiftly and reliably.

The relative movement of the part of the stack in relation to the introduction means and to the draw-off means may be such that the storage region or a stack carrier for holding a stack of articles which is stored in the storage region is stationary, that is to say remains unaccelerated, and the introduction means and the draw-off means are accelerated for carrying out the relative movement.

A simpler incorporation of the introduction means and of the draw-off means into a transport train can be achieved if the stack or the stack carrier are accelerated during the movement and the introduction means and the draw-off means are stationary or can execute other movements. The movement of the stack or stack carrier then takes place in relation to a carrying device for carrying the stack carrier, for example a stand or a substructure. It is likewise conceivable to accelerate both the stack and the introduction means and draw-off means, expediently contradirectionally, so that an acceleration can have less effect on the stack.

The movement of at least part of the stack expediently takes place parallel to a flat side of the stacked articles. This movement may be perpendicular to the stacking direction of the stack. As a result, the stack or its article last stored can be moved away from the introduction means and toward the draw-off means particularly reliably and unsusceptibly to faults, without many elements having to be moved.

The movement advantageously takes place in the longitudinal direction of the stacked articles, that is to say expediently in an introduction direction in which the articles are moved onto a stop. An uninterrupted further transport of the article last introduced into the storage region can thereby be achieved.

The movement means for moving at least part of the stack can be kept particularly simple if the movement is a straight translational movement of the overall stack.

If the movement is a pivoting movement of the stack, then acceleration forces on the stack can be kept low. Since an at least substantial translational movement of the article last stacked along the introduction means and the draw-off means is particularly beneficial, a pivot axis of the pivoting movement preferably lies such that the article last stacked of all the stacked articles is furthest away from the pivot axis.

When the stack is accelerated to carry out the movement, the stack should as far as possible not be moved in relation to a stack carrier for holding the stack, that is to say it should not or should as little as possible slip on the latter. This can be carried out the more easily, the lower the acceleration on the stack is. The stack is particularly unstable in its middle region. The acceleration on the stack can be kept low, particularly in the middle region, if the stack carrier is arranged on both sides of a pivot axis of the pivoting movement. The overall stack can be pivoted about the pivot axis in the manner of two propeller blades lying opposite one another, and the middle region can remain at least essentially stationary. For this purpose, the pivot axis is expediently led through the storage region, in particular through the center of gravity of a stack of maximum length.

In a further embodiment of the invention, the storage module comprises a stop with a stop position for stopping an introduction movement of the articles and a movement element for moving the stop out of the stop position into a release position. The articles, when being drawn off, can be led past the stop in a particularly simple way.

A movement of the stop is expediently coupled positively to the movement of the stack. As a result, the stop can be drawn back, for example automatically, when the stack is moved and thereby be changed over from an introduction function to a draw-off function. The movement of the stop is expediently in relation to the stack carrier.

It is proposed, moreover, that the storage module advantageously comprise a process means for controlling a speed of the movement, in particular such that the speed is equal to a speed of introduction of articles into the storage region. The stack can be moved even while the last article is being shot into the stack, without a relative speed between the moved stack and the last articles occurring at any time point. A particularly swift changeover between the stacking function and the draw-off function can be achieved.

The process means for controlling a speed of the movement is expediently provided in such a way that an article introduced last into the storage region is drawn off and transported further on without an interruption in the introduction movement. A changeover from an introduction function to a draw-off function can therefore take place without an interruption or with only a minor interruption in an article stream on the storage module.

During the movement of the stack, it is advantageous if the latter is supported in the direction of movement, so that a break-up of the stack is prevented. For this purpose, the storage module advantageously comprises a stack carrier for holding the stack of articles, with a pushing means for bearing against a trailing edge of articles stacked in the storage region and for pushing the articles in the direction of movement. With front and rear having to be seen in relation to the introduction direction, so that, when an article is being introduced, the trailing edge is the rear edge, the stack can be supported by the trailing edges, and therefore a slipping of the stack out of place on the stack carrier is counteracted.

The pushing means advantageously comprises a plurality of edges which are arranged one behind the other in a stair-like manner in the longitudinal direction of the articles. The trailing edge of an article can be supported by an edge, and the article can thereby be pushed in the direction of movement by the edge, with the result that a movement of the article in relation to the stack carrier can be at least substantially avoided. Articles of different length can be supported by the plurality of edges arranged one behind the other.

In a further advantageous refinement of the pushing means, the pushing means has a brush element for bearing against the trailing edges. The brush, when being pressed onto the stack, adapts itself automatically to the stack shape and thereby supports the stack. The brush element is expediently laid against the stack, that is to say moved toward it, before the start of the movement of the latter, so that the brush does not previously disturb a stacking movement of the stack in the stacking direction. For this purpose, the stack carrier expediently comprises a movement means for moving the brush element toward the stack, the movement expediently being a pivoting movement and, in particular, being coupled positively to the movement of the stack.

The invention relates, moreover, to the use of a storage module, as described above, for the storage of flat articles.

The invention is explained in more detail by means of exemplary embodiments illustrated in the drawings in which:

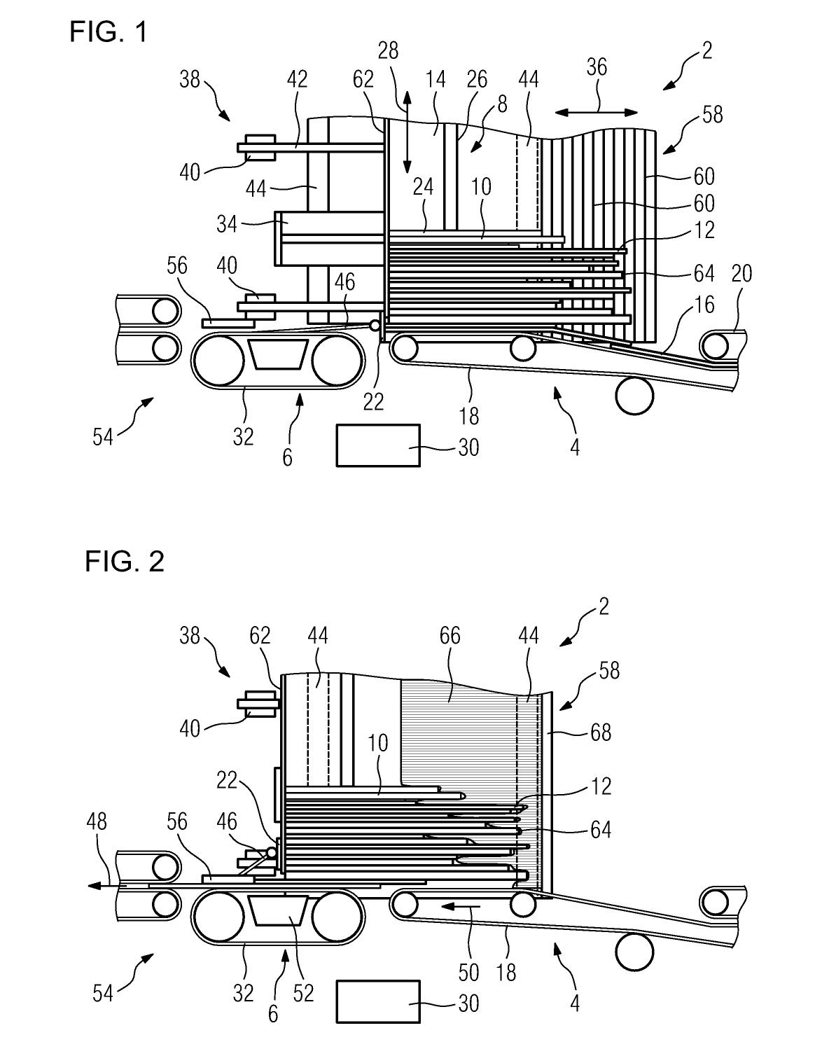

FIG. 1 shows a top view of a storage module with an introduction means and with a draw-off means in an introduction operating mode,

FIG. 2 shows the storage module from FIG. 1 in a draw-off operating mode,

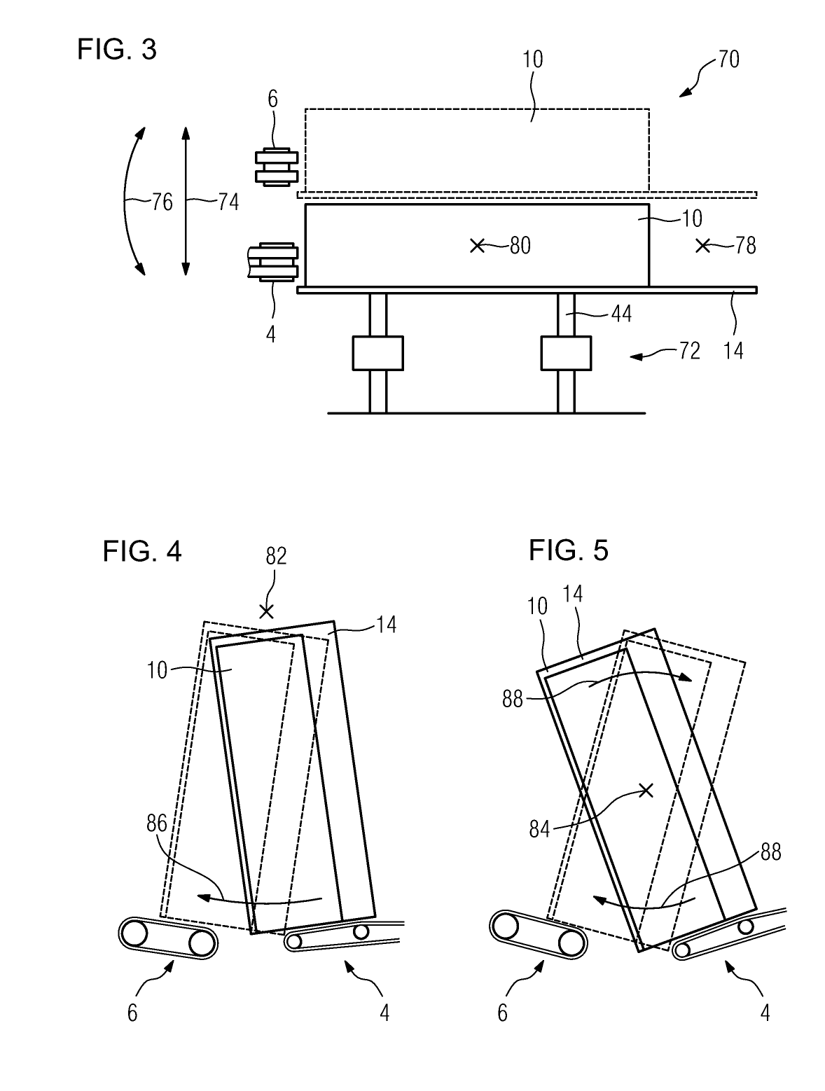

FIG. 3 shows a storage module which can be moved vertically from an introduction operating mode into a draw-off operating mode,

FIG. 4 shows a storage module which can be moved from an introduction operating mode into a draw-off operating mode by means of a pivoting movement, and

FIG. 5 shows a storage module which can be moved from an introduction operating mode into a draw-off operating mode by means of another pivoting movement.

FIG. 1 shows a diagrammatic top view of a storage module 2 with an introduction means 4 and a draw-off means 6 and with a stack 10 of stacked articles 12 which is arranged in a storage region 8. The articles 12 are postal consignments which in the storage module 2 stand on their lower longitudinal edge on a stack carrier 14 of the storage module 2. It is also conceivable, however, to store the articles 12 lying flat in the storage module 2.

The introduction means 4 and the draw-off means 6 are arranged at the same end of the stack 10. The storage module 2 is shown in FIG. 1 in an introduction mode in which the stack 10 is arranged on the introduction means 4. Articles 12 from an article stream 16 are transported by endless belts 18, 20 of the introduction means 4 in the direction of the stack 10 and are shot in at a high speed of, for example, above 4 m/s between the belt 18 and the end of the stack 10, so that the article 12 last introduced butts against a stop 22 and is stopped there.

For the frictionless stacking of the articles 12 from the article stream 16 into the storage region 8, the articles 12 previously spaced apart from one another in the article stream 16 are pushed together into an imbricated stream, as indicated in FIG. 1, so that the articles 12 reach the stack 10 with a slight overlap. A supporting means 24, designed as a paddle, at the other end of the stack 10 prevents a tilting of the articles 12 in the stack 10 and can be moved in translation in the stacking direction 28, for example, along a rail element 26 or in another way. The movement of the supporting means 24 is controlled by a process means 30 which is connected to a sensor, not illustrated, for measuring the stack pressure in the stack 10. If the stack pressure overshoots a predetermined value, the supporting means 24 is moved a little way to the rear in the stacking direction 28.

When stacking comes to an end, for example because the article stream 16 has ceased, and the articles 12 of the stack 10 are to be separated into a new article stream, the storage module 2 changes from the introduction operating mode to the draw-off operating mode which is illustrated in FIG. 2. For this purpose, the stack 10 must be moved to the draw-off means 6, in order to come into frictional force-generating contact with the belt 32 of the latter for drawing off the articles 12. For this purpose, the stack carrier 14 can be moved in translation in a direction of movement 36, for example, by means of a rail system 34. The direction of movement 36 is in this case oriented parallel to a flat side of the stacked articles 12 and, in particular, parallel to their longitudinal edge, in its longitudinal direction, with which the articles 12 stand on the stack carrier 14.

For carrying out the movement in the direction of movement 36, the storage module 2 comprises a movement means 38 with electric drives 40 which, controlled by the process means 30, transmit a force to toothed belts 42 which draw the stack carrier 14 to or fro in the direction of movement 36. A drive 40 without toothed belts 42 and an alternative means for the transmission of force for moving the stack carrier 14 may also be envisaged.

FIG. 2 shows the storage module 2 in a draw-off operating mode with the stack carrier 14 in a draw-off position. As compared with the introduction operating mode from FIG. 1, the stack carrier 14 is displaced in the direction of movement 36 by somewhat more than 10 cm in relation to a carrying device 44 which carries the stack carrier 14 and, for example, stands on a floor. During this movement the stop 22 has been moved by a movement element 46 from its stop position, shown in FIG. 1, into a release position, shown in FIG. 2, the movement of the stop 22 being coupled positively to the movement of the stack carrier 14.

During a movement of the belt 32 of the draw-off means 6, then, the article 12 last stacked, which then bears against the belt 32, is drawn by the belt 32 in a draw-off direction 48 which is parallel to an introduction direction 50 of the introduction means 4. To assist the force transmitted from the belt 32 to the article 12 as a result of friction, the draw-off means 6 comprises a suction unit 52 for generating a vacuum which can penetrate through recesses in the belt 32 or between the belts 32 as far as the article 12 to be drawn off. As a result of frictional action, the article 12 to be drawn off is accelerated to a draw-off speed, which is controlled by the process means 30, and is transferred to a transport system 54 for the further transport of the articles 12 then arranged in an article stream.

In order at least as far as possible to avoid double draw-offs, the draw-off means 6 comprises a stripper 56 for stripping off one or more further articles 12 lying on an article 12 to be drawn off. To assist the frictional action of the belt 32 on the article 12 to be drawn off, the belt 32 is provided with a soft covering having a high coefficient of friction on paper which is substantially higher than that of a covering of the belt 18 of the introduction means 4.

A relative speed between a moved article 12 and the belt 18 therefore entails only an insignificant mechanical load on the article 12.

To maintain an article stream 16, the process means 30 is prepared in such a way that it controls the movement of the stack carrier 14 in the direction of movement 36 away from the introduction means and toward the draw-off means 6 at an introduction speed at which the articles 12 in the article stream 16 are introduced into the stack 10. The movement of the stack carrier 14 may in this case be controlled such that the stack carrier 14 is being accelerated in the direction of movement toward the draw-off means 6 even when the article 12 last stacked has not yet reached the stop 22. This article 12 is therefore not braked or hardly braked, whereas the stack 10 is accelerated to the speed of this article 12. The article 12 last stacked reaches the draw-off means 6 and is sucked by the suction unit 52 onto the belt 32, picked up by the latter and transported further on to the transport system 54 at the draw-off speed, which may be equal to the introduction speed, without an interruption in the introduction movement.

On account of the high acceleration of the stack carrier 14 in the direction of movement 36 toward the draw-off means 6, it is necessary to transmit a high force to the stack 10 for its acceleration. Owing to the inertia of the stack 10, it may happen that it lags behind in its movement and slips out of place on the stack carrier 14. A long stack 10 may in this case bend in a middle region, so that the stack 10 becomes disorganized and can no longer be drawn off.

In order to avoid this, the storage module 2 comprises on the stack carrier 14 a pushing means 58 for pushing the stack 10 in the direction of movement 36 toward the draw-off means 6 at or shortly after the start of a slipping out of place of the stack 10 on the stack carrier 14. The pushing means 58, shown from above in FIG. 1, comprises a number of edges 60 which ascend in a stair-like manner from left to right, that is to say opposite to the introduction direction 50. The articles 12 of the stack 10 are thereby, on the one hand, held at their leading edge against a stop 62 of the stack carrier 14 and, on the other hand, held with their trailing edge 64 at the next edge 60 which is arranged behind the trailing edge 64 and against which the trailing edge 64 of the articles 12 butts when they slip onto the stack carrier 14. A considerable slipping of the stack 10 out of place and, in particular, a break-up of the stack 10 are thereby reliably avoided.

To illustrate another exemplary embodiment, the pushing means 58 is provided in FIG. 2, instead of with the edges 60, with a brush element 66 which comprises a brush fastened to a carrier 68. The brush engages between the articles 12, as is illustrated diagrammatically by the meandering line of the brush element 66 in FIG. 2, and presses the articles 12 at their trailing edges 64 toward the stop 62. So as not to obstruct a stacking and an associated movement of the stack 10 in a stacking direction 28, the brush element 66 may be moved, for example by being swung in, against the trailing edges 64 of the stack 10 only after or shortly before the conclusion of the introduction operating mode.

FIG. 3 shows an alternative storage module 70 in a diagrammatic side illustration. The following description is restricted essentially to the differences from the exemplary embodiment in FIGS. 1 and 2 to which reference is made in respect of features and functions which remain the same. Components essentially remaining the same are basically designated by the same reference symbols.

The storage module 70 has essentially the same set-up as the storage module 2, but comprises an alternative movement means 72 for moving the stack carrier 14 in a vertical direction of movement 74. The draw-off means 6 is in this case arranged vertically above the introduction means 4, so that the stack 10, when moved from the introduction means 4 to the draw-off means 6, is guided upward. As a result, a good hold of the stack 10 on the stack carrier 14 can be achieved, and an unwanted break-up of the stack 10 does not occur. For clarity, the stack 10 and the stack carrier 14 are illustrated by unbroken lines in the introduction operating mode and by dashes in the draw-off operating mode at the draw-off means 6.

It is also conceivable, of course, to arrange the introduction means 4 above the draw-off means 6. This is advantageous particularly when a translational direction of movement 74 is not selected, but, instead, a rotational direction of movement 76 about a pivot axis 78 or pivot axis 80. However, the speed of movement of the stack 10 should in this case not overshoot a falling speed, in order to prevent the stack 10 from being lifted off from the stack carrier 14. Thus, in this configuration, stacking in an upper position of the stack can take place by the stack 10 being pressed somewhat away from the introduction means 4 as a result of gravity. Conversely, in the draw-off operating mode in the lower position, the stack 10 is pressed somewhat onto the draw-off means 6 as a result of gravity. Depending on the direction of movement 74, 76 either by translation or about the pivot axis 78 or 80, more, less or even less energy is necessary for accelerating the stack 10. In a movement about the pivot axis 80, the stack carrier 14 for holding the stack 12 is arranged on both sides of the pivot axis 80.

A movement of the stack 10 or stack carrier 14 about a pivot axis 82 outside the stack 10 or about a pivot axis 84 inside the stack 10 may likewise be envisaged, as illustrated in FIGS. 4 and 5. In this case, the stack 10 or its article 12 last placed onto the stack is likewise moved in a rotational direction of movement 86, 88. This, too, makes it possible to counteract a break-up of the stack 10, since, above all in the exemplary embodiment from FIG. 5, only low forces act on the middle region of the stack 10. However, as described with regard to FIG. 1 or FIG. 2, the outer regions must advantageously be supported in order to stabilize the stack 10 on the stack carrier 14. In a similar way to FIG. 3, in FIGS. 4 and 5 the stack 10 and the stack carrier 14 are illustrated by dashes in the draw-off operating mode of the draw-off means 6.

In a further design variant, a relative movement of the stack carrier 14 in relation to the introduction means 4 and to the draw-off means 6 may be envisaged, in such a way that the stack carrier 14 is stationary on the carrying device 44 and the introduction means 4 and draw-off means 6 are accelerated for the change from the introduction operating mode to the draw-off operating mode or back and move in relation to the carrying device 44. The stack 10 can in this case remain stationary and is thereby optimally stable. However, it is necessary to adapt the introduction means 4 or draw-off means 6 to the delivering or discharging transport system 54, for example by the length of the latter being variable under the control of the process means 30.

1-16. (canceled)

17. A storage module for flat articles, comprising:
a storage region for a stack of articles;
an introduction unit for introducing articles from an article stream into said storage region;
a draw-off unit, arranged at a same end of the stack as said introduction unit, for drawing off articles from said storage region, and
a movement device for moving at least a part of the stack which includes an article deposited last in said storage region away from said introduction unit toward said draw-off unit.

18. The storage module according to claim 17, including a stack carrier for holding the stack of articles, and a drive device for moving said stack carrier between said introduction unit and said draw-off unit.

19. The storage module according to claim 17, including a stack carrier for holding the stack of articles, a carrying device for carrying said stack carrier, said movement device constructed to move at least part of the stack in relation to said carrying device away from said introduction unit and toward said draw-off unit.

20. The storage module according to claim 17, wherein said movement device moves at least a part of the stack in a direction substantially parallel to a flat side of the stacked articles.

21. The storage module according to claim 17, wherein said movement device moves at least a part of the stack in a longitudinal direction of the stacked articles.

22. The storage module according to claim 17, wherein said movement device moves at least a part of the stack in a straight translational direction of the overall stack.

23. The storage module according to claim 17, wherein said movement device moves at least a part of the stack in a pivotal direction of the stack.

24. The storage module according to claim 23, wherein a stack carrier for holding the stack is arranged on both sides of a pivot axis of the pivotal direction.

25. The storage module according to claim 17, including a stop having a stop position for stopping an introduction of the articles, and a movement element for moving said stop out of the stop position into a release position.

26. The storage module according to claim 25, wherein said stop is coupled by force to a movement of the stack.

27. The storage module according to claim 17, including a process device for controlling a speed of the movement that it is equal to a speed of introduction of articles into said storage region.

28. The storage module according to claim 17, including a process device for controlling a speed of the movement such that an article introduced last into said storage region is drawn off and transported further without an interruption in the introduction movement.

29. The storage module according to claim 17, including a stack carrier for holding the stack of articles, and a pushing device which bears against a trailing edge of articles stacked in said storage region and pushes the articles in the direction of movement.

30. The storage module according to claim 29, wherein said pushing device has a plurality of edges arranged one behind the other in a stair-like configuration in a longitudinal direction of the articles.

31. The storage module according to claim 29, wherein said pushing device has a brush element which bears against the trailing edges.

32. The storage module according to claim 17, wherein said draw-off unit includes a draw-off element to draw on an article to be drawn off, and said introduction unit has an introduction element to push an article into said storage region, said draw-off element has a higher coefficient of friction than that of said introduction element.
